(19) United States
(12) Patent Application Publication
(10) Pub. No.: US 2006/0150484 A1
(43) Pub. Date: Jul. 13, 2006

(54) String for agricultural use

(76) Inventor: Ezio Morandi, Rovereto (IT)

Correspondence Address: Thomas S Baker Jr, 1371 West 3rd Avenue, Columbus, OH, 43212, US

(21) Appl. No.: 10/543,876

(22) PCT Filed: Nov. 12, 2003
(86) PCT No.: PCT/EP03/12795

§ 371 Date: Jul. 28, 2005

(30) Foreign Application Priority Data
Feb. 13, 2003 (IT) MI2003U000055

(51) Int. Cl. A01G 17/06

(52) U.S. Cl. 47/44

(57) ABSTRACT

A string for agricultural use is described, comprising at least one cord 11 and a stop element 14, wherein said cord 11 is folded according to a configuration such that it forms ends 13 and at least one ring 12 and said stop element 14 is provided with at least one hole 15 through which said ends 13 can slide to adjust the width of the ring for performing plant tying operations. The strings according to the invention are of different thickness and length according to their use.

The present invention is about a string for agricultural use having considerable characteristics of utility and usability.

As it is known, the term string is used to identify a binding to tie up plants in any regional cultivation. To tie up the plants, like for example vine-shoots, the farmer generally uses skeins of plastic wires, properly cut in small pieces and subsequently tied around the plant, or its branches, to be fastened. A different embodiment present on the market consists of bags containing bunches of previously cut plastic wires that the user ties, forming properly sized rings according to the diameter of the plants to be fastened.

It is evident that, to provide for the plant tying through this method, a rather long time is required, due to the need to perform a wire tying process around the branch or the plant, although it has been proved that such method is convenient for the low cost of the material.

An alternative method uses a set of elastic bands made of PVC-rubber profiles, each having a properly sized circumference to be adapted to the diameter of the plant or branch to be tied up, which clearly do not need any knot and thus require less time for its application. If this method has allowed the farmer to save time on one side, it is much more expensive on the other side, requiring the previous manufacture of elastic bands of different size.

Moreover, both the cited methods do not allow to subsequently recover and reuse the strings in the same or in other cultivations since, once the knot has been performed around the branch or the plant or the elastic band has been applied, the ring has to be opened by cutting to release the plant or the branch.

It is thus an object of the present invention to provide for a string which allows a quick tying of the plant and which is contemporarily recoverable and reusable in a different cultivation stage of the same or other plant.

Said object is attained by a string according to claim 1, to which reference is made for sake of brevity.

The present invention is described in detail hereinafter, in an explanatory and not limiting way, with reference to the annexed drawings wherein:

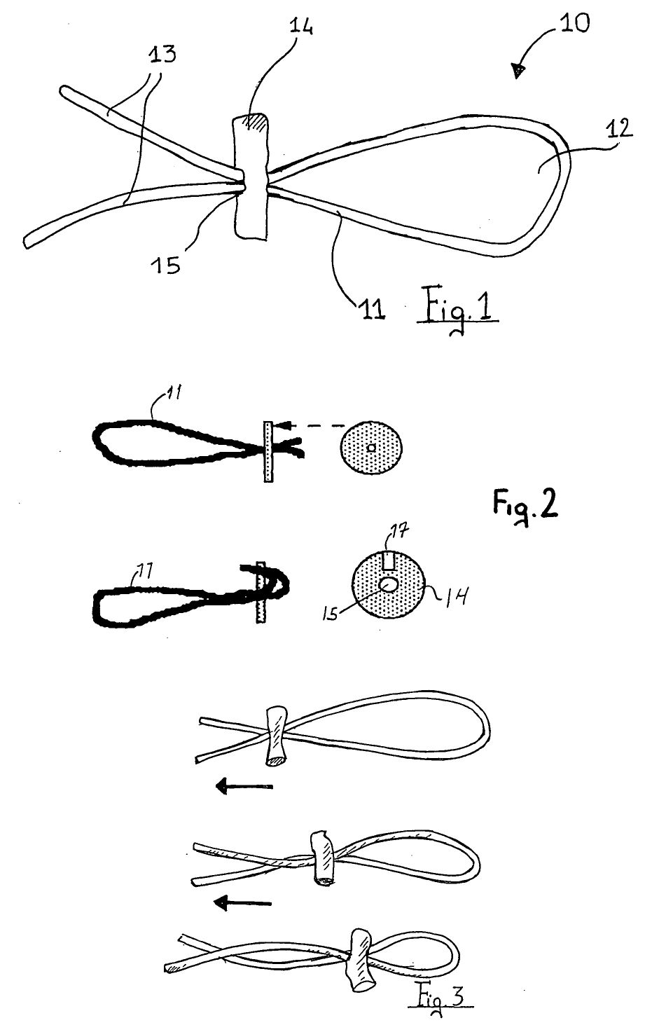

FIG. 1 is a front view of the string according to a first embodiment of the present invention;

FIG. 2 shows the string according to a second embodiment of the invention; and

FIG. 3 is a perspective view of the present invention, showing the possibility to shape the present invention with different sizes.

The string according to the present invention, shown in FIG. 1, is generally indicated with numeral 10 and it comprises a plastic material cord 11 folded according to a configuration such that it forms a ring 12 and ends 13.

The ends 13 of the plastic material cord 11 are kept joined by a stop element 14 which, according to the first embodiment of the invention, is a cord made of plastic material, said ends 13 passing through a hole 15 of the cord and remaining free to translate through said hole 15 of the stop element 14.

Therefore, the ends 13 of the first cord 11 can slide outwardly through the hole 15 of the stop element 14, reducing the width of the ring 12, or they can also slide inwardly, increasing the circumference of the ring 12.

In FIG. 3 the previously described movement, allowing to obtain several and proper sizes of the ring 12 of the string 10, is shown. In fact, the ends 13 can slide through the hole 15 in the arrow direction, reducing the circumference of the ring 12, or they can also slide in the opposite arrow direction, in order to increase the circumference.

In a second embodiment of the invention, shown in FIG. 2, a round plate or washer 14 is used as a stop member 14. The movement described hereinbefore and shown in FIG. 3 is the same for this embodiment. In this embodiment, the possibility of a slot 17 on the stop element 14, able to block the ends 13 exiting from the hole 15, is provided.

The string according to the invention is thus easy and quick to use like the elastic band according to the prior art, but it is reusable with respect to said elastic band since, by the translation movement of the ends 13 through the hole 15, it is possible to free the branch or the plant by completely opening the ring and then re-forming it, inserting again said end previously extracted from the two ends 13 into the hole 15 of the stop element 14. Alternatively, according to the present invention, the ring width could be simply increased to allow the previously tied up part of the plant to exit, thus maintaining intact the ring structure.

Said string 10 could be made of any material but, in particular, it could be made of plastic material of the tubular flexible kind used in the skeins according to the prior art, that is of low cost and easy to find. Preferably, the plastic material is of ecological biodegradable kind. The stop element 14 can be made of any material but, in particular, it can be made of flexible plastic material or, still preferably, of metal or solid plastic.

From the aforesaid description, the considerable usability, versatility and easiness of use of the string 10 according to the invention is evident.

It is also provided that the stop element 14 has a set of distinct holes 15, through each of which a corresponding number of cords 11 can slide, forming a sequence of rings 12 on the same stop element 14.

Finally, the present invention is suitable for numerous modifications and variations, like for example the stop element shape, all within the innovative concept exposed in the appended claims, while the technical details can change according to the needs.

1. A string for agricultural use, comprising at least one cord (11), characterized by comprising a stop element (14), said cord (11) being folded and the stop element (14) being provided with at least a hole (15) through which pass the ends of the cord (11) performing the tying of the plant.

2. The string according to claim 1, wherein said cord (11) is folded in order to form a ring (12) and ends (13), said ends (13) being able to slide in the hole (15) to adjust the width of the ring (12) according to the size of the plant to be tied.

3. The string according to claim 1, wherein the stop element (14) is provided with a set of holes (15) through at least two of which at least two folded cords (11) pass.

4. The string according to claim 1, wherein the cord (11) consists of lengths of a tubular element made of flexible plastic material.

5. The string according to claim 4, wherein the plastic material is of ecological biodegradable kind.

6. The string according to claim 1, wherein the stop element (14) consists of a tubular element or a profile of flexible plastic material.

7. The string according to claim 1, wherein the stop element (14) is made of solid plastic material.

8. The string according to claim 7, wherein the stop element is provided with a slot (17) able to block the ends (13) of the cord (11).

9. The string according to claim 1, wherein the stop element (14) is made of metal.

10. The string according to claim 9, wherein the stop element is provided with a slot (17) able to block the ends (13) of the cord (11).
